(19) United States
(12) Patent Application Publication
(10) Pub. No.: US 2024/0387879 A1
(43) Pub. Date: Nov. 21, 2024

(54) Method for Manufacturing Electrode Body for Non-Aqueous Electrolyte Solution Rechargeable Battery and Method for Manufacturing Non-Aqueous Electrolyte Solution Rechargeable Battery

(71) Applicants: PRIMEARTH EV ENERGY CO., LTD., Shizuoka (JP); TOYOTA JIDOSHA KABUSHIKI KAISHA, Aichi-Ken (JP); PRIME PLANET ENERGY & SOLUTIONS, INC., Tokyo (JP)

(72) Inventors: Takaaki Izumoto, Toyohashi-shi (JP); Kentaro Suzuki, Kariya-shi (JP)

(21) Appl. No.: 18/662,864

(22) Filed: May 13, 2024

(30) Foreign Application Priority Data
May 15, 2023 (JP) 2023-080386

(51) Int. Cl. H01M 10/0587; H01M 4/02; H01M 4/04; H01M 4/139; H01M 4/62; H01M 10/0525

(52) U.S. Cl. CPC H01M 10/0587; H01M 4/0404; H01M 4/043; H01M 4/139; H01M 4/625; H01M 10/0525; H01M 2004/021; H01M 2004/028

(57) ABSTRACT

In a method for manufacturing an electrode body for a non-aqueous electrolyte solution rechargeable battery, when a roll shaping load PL (MPa) corresponds to a load in a roll pressing step at which a difference ΔT between a thickness T₁ mm of the electrode body pressed at 1.2 MPa after the roll pressing step and a thickness T₂ of the electrode body pressed at 0.03 MPa after the roll pressing step is less than or equal to 0.4 mm, a thickness A (μm) of a cathode plate after a cathode applying step, a cathode weight per unit area B (mg/cm²) of a cathode mixture layer applied in a cathode applying step, and a thickness C (μm) of the cathode plate after a cathode pressing step are adjusted so that the roll shaping load PL (MPa) is less than or equal to 11 MPa.

### CROSS-REFERENCE TO RELATED APPLICATIONS

This application is based upon and claims the benefit of priority from prior Japanese Patent Application No. 2023-080386, filed on May 15, 2023, the entire contents of which are incorporated herein by reference.

### BACKGROUND

### 1. Field

The following description relates to a method for manufacturing an electrode body for a non-aqueous electrolyte solution rechargeable battery and a method for manufacturing a non-aqueous electrolyte solution rechargeable battery. More particularly, the following description relates to a method for manufacturing an electrode body for a non-aqueous electrolyte solution rechargeable battery and a method for manufacturing a non-aqueous electrolyte solution rechargeable battery that readily avoid excessive plastic deformation of a separator when the electrode body is pressed.

### 2. Description of Related Art

Non-aqueous electrolyte solution rechargeable batteries, such as lithium-ion rechargeable batteries, have a high energy density, a high voltage, and a high output. Thus, such a non-aqueous electrolyte solution rechargeable battery is mounted on a vehicle, such as a battery electric vehicle, a hybrid electric vehicle, or the like, as a power supply. The vehicle on-board non-aqueous electrolyte solution rechargeable battery includes an electrode body, a non-aqueous electrolyte solution, and a box-shaped battery case accommodating the electrode body and the non-aqueous electrolyte solution. The electrode body is formed by rolling, so as to reduce the size, a stack of a cathode plate and an anode plate with a separator disposed in between. Then, the roll of the electrode body is flattened in a pressing step in accordance with the inner dimension of the battery case. Manufactured battery cells are stacked and used as a battery pack. In this case, each electrode body accommodated in the battery case is pressed at a certain pressure or greater in order to improve stability and pressure resistance of the battery pack.

When flattening the roll of the electrode body by a conventional pressing method, simply increasing the compressing load applied to the electrode body may crush pores in the separator and increase the resistance of the battery cell. Accordingly, Japanese Laid-Open Patent Publication No. 2012-059491 describes that an electrode body is softened by performing a heat treatment on cathode and anode plates to improve moldability of the electrode body during a pressing step.

Further, Japanese Laid-Open Patent Publication No. 2013-206587 describes that an electrode body is heated to stabilize the shape of the electrode body. The heated electrode body is then pressed.

In such configurations, the cathode plate and the like are softened by heating so that the electrode body can be flattened with a relatively small load without crushing the pores of the separator.

However, heating of an electrode body may require a heating facility and thus incur facility costs. Also, heating and cooling of the electrode body may adversely affect the production time and decrease production efficiency.

### SUMMARY

In one general aspect, a method is provided for manufacturing an electrode body for a non-aqueous electrolyte solution rechargeable battery. The non-aqueous electrolyte solution rechargeable battery includes the electrode body, a non-aqueous electrolyte solution, and a box-shaped battery case accommodating the electrode body and the non-aqueous electrolyte solution. The method includes a cathode applying step, a cathode pressing step, a stacking step, a rolling step, and a roll pressing step. The cathode applying step includes applying a cathode mixture layer on a cathode current collector foil of the electrode body to form a cathode plate. The cathode pressing step includes pressing the formed cathode plate. The stacking step includes stacking the pressed cathode plate and an anode plate with a separator formed from a porous resin arranged in between. The anode plate includes an anode current collector foil and an anode mixture layer. The rolling step includes rolling the stacked electrode body. The roll pressing step includes pressing the rolled electrode body to flatten the rolled electrode body. When a roll shaping load PL (MPa) corresponds to a load in the roll pressing step at which a difference ΔT between a thickness T₁ mm of the electrode body pressed at 1.2 MPa after the roll pressing step and a thickness T₂ of the electrode body pressed at 0.03 MPa after the roll pressing step is less than or equal to 0.4 mm, a thickness A (μm) of the cathode plate after the cathode applying step, a cathode weight per unit area B (mg/cm²) of the cathode mixture layer applied in the cathode applying step, and a thickness C (μm) of the cathode plate after the cathode pressing step are adjusted so that the roll shaping load PL (MPa) is less than or equal to 11 MPa.

In another general aspect, a method is provided for manufacturing an electrode body for a non-aqueous electrolyte solution rechargeable battery. The non-aqueous electrolyte solution rechargeable battery includes the electrode body, a non-aqueous electrolyte solution, and a box-shaped battery case accommodating the electrode body and the non-aqueous electrolyte solution. The method includes a cathode applying step, a cathode pressing step, a stacking step, a rolling step, and a roll pressing step. The cathode applying step includes applying a cathode mixture layer on a cathode current collector foil of the electrode body to form a cathode plate. The cathode pressing step includes pressing the formed cathode plate. The stacking step includes stacking the pressed cathode plate and an anode plate with a separator formed from a porous resin arranged in between. The anode plate includes an anode current collector foil and an anode mixture layer. The rolling step includes rolling the stacked electrode body. The roll pressing step includes pressing the rolled electrode body to flatten the rolled electrode body. When a cathode density change amount ΔPD (g/cm³) is obtained from Equation 1, where A (μm) represents a thickness of the cathode plate after the cathode applying step, B (mg/cm²) represents a cathode weight per unit area of the cathode mixture layer applied in the cathode applying step, C (μm) represents a thickness of the cathode plate after the cathode pressing step, and D (μm) represents a thickness of the cathode current collector foil,

$$\begin{matrix}Cathode Density Change Amount \\ Δ PD ( g / {cm}^{3} )\end{matrix} = \frac{B \times 10}{C - D} - \frac{B \times 10}{A - D} \qquad ( Equation 1 )$$

the thickness A (μm) of the cathode plate after the cathode applying step, the cathode weight per unit area B (mg/cm²), the thickness C (μm) of the cathode plate after the cathode pressing step, and the thickness D (μm) of the cathode current collector foil are adjusted so that the cathode density change amount ΔPD is less than or equal to 1.0 g/cm³.

In the above method, wherein the thickness A (μm) of the cathode plate after the cathode applying step, the cathode weight per unit area B (mg/cm²), the thickness C (μm) of the cathode plate after the cathode pressing step, and the thickness D (μm) of the cathode current collector foil may be adjusted so that the cathode density change amount ΔPD is greater than or equal to 0.63 g/cm³.

In the above method, in the roll pressing step, the rolled electrode body may be pressed at room temperature without heating the electrode body.

In the above method, the cathode mixture layer may include a conductor, and the conductor may include carbon nanotubes.

The present disclosure may include the above method for manufacturing an electrode body for a non-aqueous electrolyte solution rechargeable battery as part of a method for manufacturing a non-aqueous electrolyte solution rechargeable battery.

Other features and aspects will be apparent from the following detailed description, the drawings, and the claims.

### BRIEF DESCRIPTION OF DRAWINGS

FIG. 1 is a perspective view of a lithium-ion rechargeable battery in accordance with the present embodiment.

FIG. 2 is a schematic diagram showing the structure of a stack forming an electrode body of the lithium-ion rechargeable battery.

FIG. 3 is a schematic diagram showing the structure of a roll of the electrode body of the lithium-ion rechargeable battery.

FIG. 4 is a schematic diagram showing the structure of an end of the electrode body as viewed in a widthwise direction.

FIG. 5 is a graph showing the relationship between a roll shaping load PL (MPa) and a resistance increase rate (%).

FIG. 6 is a flowchart illustrating an example of a method for manufacturing the lithium-ion rechargeable battery of the present embodiment.

FIG. 7 is a flowchart illustrating a battery element manufacturing step of the lithium-ion rechargeable battery of the present embodiment.

FIG. 8 is Equation 1 for obtaining a cathode density change amount ΔPD (g/cm³).

FIG. 9 is a table showing the relationship between the cathode density change amount ΔPD (g/cm³) and the roll shaping load PL (MPa) of the present embodiment.

FIG. 10 is a graph showing the relationship between the cathode density change amount ΔPD (g/cm³) and the roll shaping load PL (MPa) of the present embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

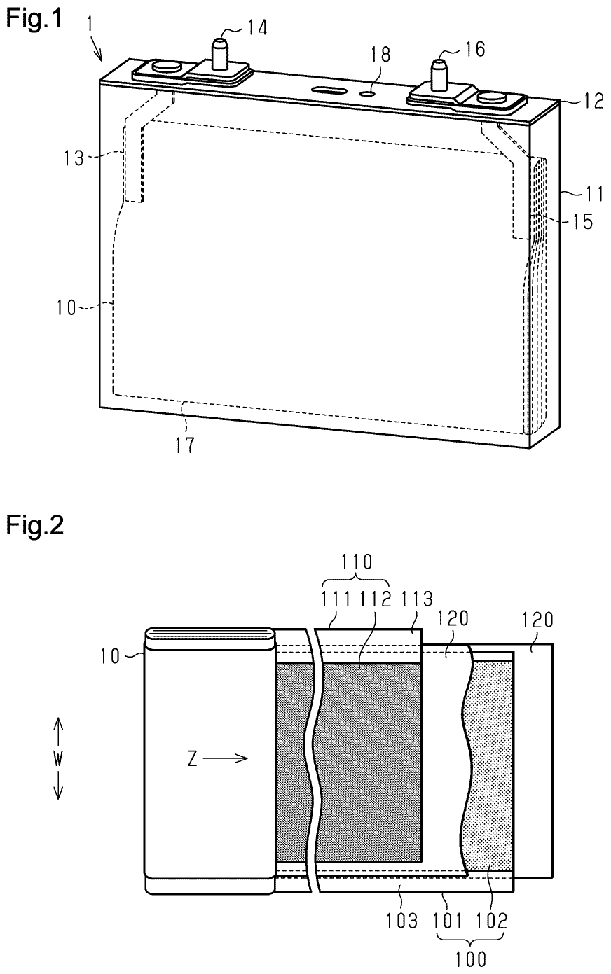

A method for manufacturing an electrode body for a non-aqueous electrolyte solution rechargeable battery and a method for manufacturing a non-aqueous electrolyte solution rechargeable battery according to the present disclosure will now be described using an embodiment of a method for manufacturing a lithium-ion rechargeable battery 1 with reference to FIGS. 1 to 10.

### Overview of the Present Embodiment

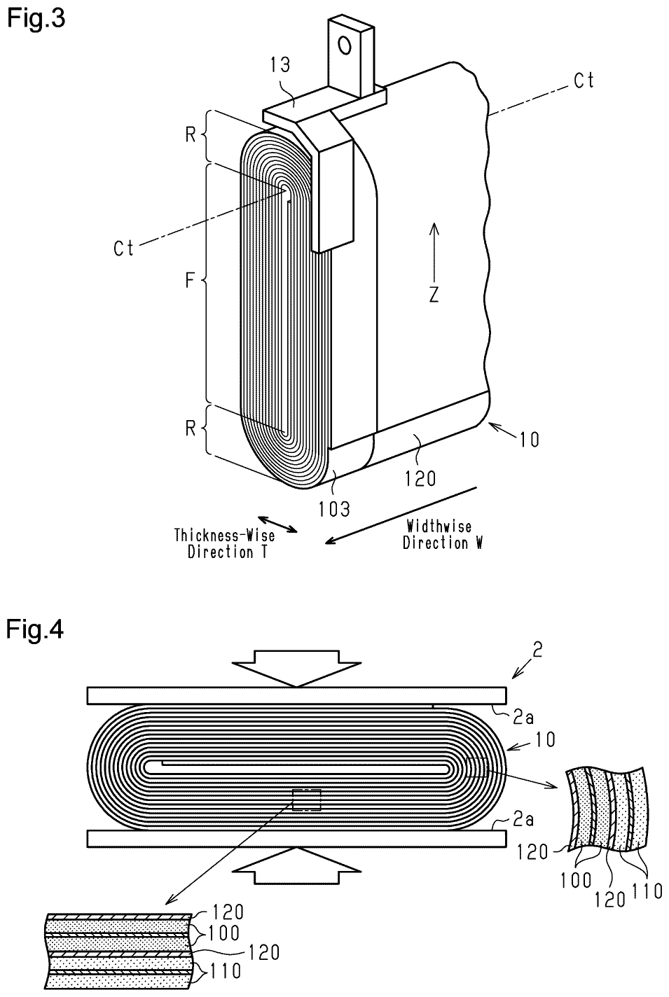

FIG. 1 is a perspective view of the lithium-ion rechargeable battery 1 in accordance with the present embodiment. FIG. 2 is a schematic diagram showing the structure of a stack forming an electrode body 10 of the lithium-ion rechargeable battery 1 in accordance with the present embodiment. FIG. 3 is a schematic diagram showing the structure of a roll of the electrode body 10 of the lithium-ion rechargeable battery 1. FIG. 4 is a schematic diagram illustrating a roll pressing step of the electrode body 10.

As described in Background section, when the roll of the electrode body 10 is flattened by a conventional roll pressing step, simply increasing the compressing load applied to the electrode body 10 may crush pores in a separator 120 and increase the resistance of the battery cell. Accordingly, Japanese Laid-Open Patent Publication Nos. 2012-059491 and 2013-206587 describe that a heat treatment is performed to soften an electrode body and improve moldability of the electrode body.

However, heating of the electrode body 10 may require a heating facility and thus incur facility costs. Also, heating and cooling of the electrode body 10 may adversely affect the production time and decrease production efficiency.

Instead of such a heat treatment, the present embodiment adjusts a thickness A (μm) of a cathode plate 110 after a cathode applying step, a cathode weight per unit area B (mg/cm²) of a cathode mixture layer 112 (cathode mixture paste) applied in the cathode applying step, and a thickness C (μm) of the cathode plate 110 after a cathode pressing step so that the pores of the separator 120 will not be crushed by a roll pressing step (S4 in FIG. 6).

In this respect, a roll shaping load PL (MPa) is obtained in order to adjust the thickness A (μm) of the cathode plate 110 after the cathode applying step (S12), the cathode weight per unit area B (mg/cm²) of the cathode mixture layer 112 (cathode mixture paste) applied in the cathode applying step, and the thickness C (μm) of the cathode plate 110 after the cathode pressing step. The roll shaping load PL (MPa) corresponds to a load in the roll pressing step (S4 in FIG. 6) at which a difference ΔT between a thickness T₁ (mm) of the electrode body 10 pressed at 1.2 MPa after the roll pressing step (S4) and a thickness T₂ (mm) of the electrode body 10 pressed at 0.03 MPa after the roll pressing step (S4) is less than or equal to 0.4 mm. For example, the thickness T₁ (mm) is measured by pressing one electrode body 10 after the roll pressing step (S4) at 1.2 MPa, and the thickness T₂ (mm) is measured by pressing another electrode body 10 after the roll pressing step (S4) at 0.03 MPa. In other words, when the electrode body 10 is pressed with the roll shaping load PL (MPa) in the roll pressing step (S4), the difference ΔT between the thickness T₁ (mm) of the electrode body 10 pressed at 1.2 MPa after the roll pressing step (S4) and the thickness T₂ (mm) of the electrode body 10 pressed with 0.03 MPa after the roll pressing step (S4) becomes less than or equal to 0.4 mm.

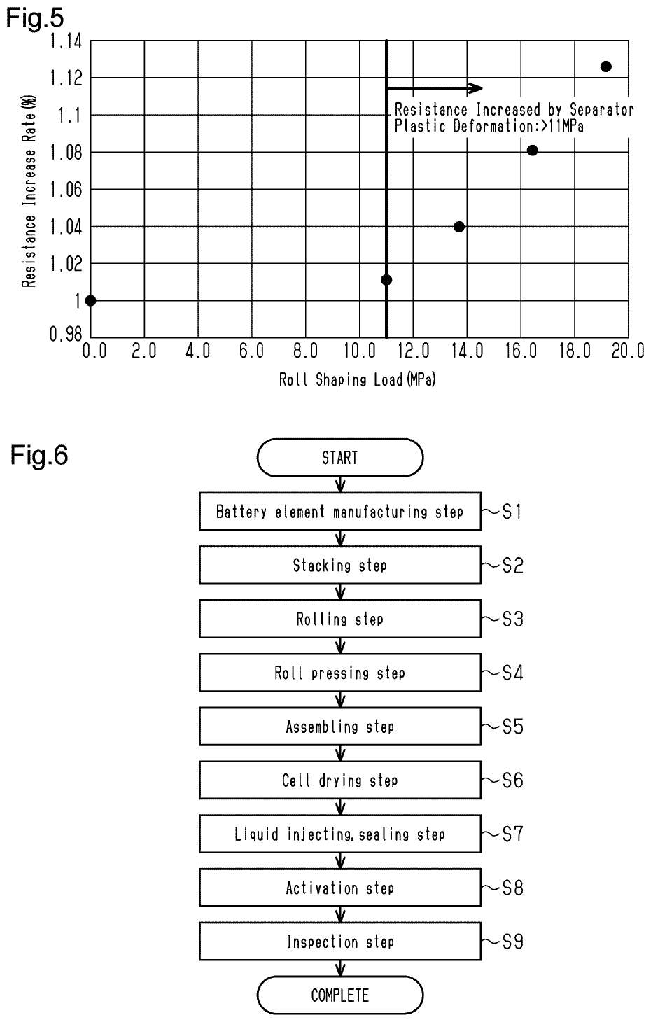

FIG. 5 is a graph showing the relationship between the roll shaping load PL (MPa) and a resistance increase rate (%). In the graph of FIG. 5, the horizontal axis represents the roll shaping load PL (MPa), and the vertical axis represents the resistance increase rate (%). The resistance increase rate (%) refers to an increase rate (%) of the internal resistance of the lithium-ion rechargeable battery 1. When the pores of the separator 120 are crushed, it becomes difficult for lithium ions Li⁺ to pass through the separator 120, thereby increasing the internal resistance. Accordingly, when the internal resistance is increased, it can be presumed that the pores were crushed in the roll pressing step (S4 in FIG. 6).

The graph shows that pores were crushed in the roll pressing step (S4 in FIG. 6) when the roll shaping load PL was greater than 11.0 MPa. The present inventors have found through experiments that the roll pressing step (S4) can be performed without crushing the pores of the separator 120 even at room temperature if the roll shaping load PL (MPa) is less than or equal to 11 MPa.

More specifically, a cathode density change amount ΔPD (g/cm³) is obtained from Equation 1 shown in FIG. 8 where A (μm) represents the thickness of the cathode plate 110 after the cathode applying step, B (mg/cm²) represents the cathode weight per unit area, C (μm) represents the thickness of the cathode plate 110 after the cathode pressing step, and D (μm) represents a thickness of a cathode current collector foil. In this case, the thickness A (μm) of the cathode plate 110 after the cathode applying step, the cathode weight per unit area B (mg/cm²), the thickness C (μm) of the cathode plate 110 after the cathode pressing step, and the thickness D (μm) of the cathode current collector foil are adjusted so that the cathode density change amount ΔPD is less than or equal to 1.0 g/cm³. Further, the thickness A (μm) of the cathode plate 110 after the cathode applying step, the cathode weight per unit area B (mg/cm²), the thickness C (μm) of the cathode plate 110 after the cathode pressing step, and the thickness D (μm) of the cathode current collector foil are adjusted so that the cathode density change amount ΔPD is greater than or equal to 0.63 g/cm³. In this manner, the roll shaping load PL (MPa) is readily adjusted to less than or equal to 11 MPa.

### Lithium-Ion Rechargeable Battery 1 of the Present Embodiment

The structure of the lithium-ion rechargeable battery 1 described in the present embodiment will now be briefly described.

FIG. 1 is a perspective view of the lithium-ion rechargeable battery 1. As shown in FIG. 1, the lithium-ion rechargeable battery 1 is structured as a battery cell. The lithium-ion rechargeable battery 1 includes a box-shaped battery case 11 having an upper opening. The battery case 11 includes a lid 12 that closes the opening of the battery case 11. The battery case 11 accommodates the electrode body (flat rolled electrode body) 10. The battery case 11 is filled with a non-aqueous electrolyte solution 17. The battery case 11 and the lid 12 are formed from metal such as an aluminum alloy. Attachment of the lid 12 to the battery case 11 forms a sealed battery casing of the lithium-ion rechargeable battery 1. The lithium-ion rechargeable battery 1 further includes an anode external terminal 14 and a cathode external terminal 16 arranged on the lid 12 and used when charging and discharging electric power. An anode current collector 13 connects an anode connector 103 (refer to FIG. 2) of the electrode body 10 and the anode external terminal 14 through the lid 12. A cathode current collector 15 connects a cathode connector 113 (refer to FIG. 2) of the electrode body 10 and the cathode external terminal 16 through the lid 12.

### Electrode Body 10

FIG. 2 is a schematic diagram showing the structure of a stack forming the electrode body 10 of the lithium-ion rechargeable battery 1. As shown in FIG. 2, the electrode body 10 of the lithium-ion rechargeable battery 1 includes an anode plate 100, the cathode plate 110, and separators 120. The anode plate 100 includes an anode mixture layer 102 on two opposite surfaces of an anode current collector foil 101. The cathode plate 110 includes the cathode mixture layer 112 on two opposite surfaces of a cathode current collector foil 111. The anode plate 100, the cathode plate 110, and the separators 120 are layered to form the stack of the electrode body (stacked body) 10. The stack is rolled in its lengthwise direction Z about a rolling axis and flattened to form the electrode body (flat rolled electrode body) 10.

The anode connector 103 is used as a current collector that extracts electricity from the anode mixture layers 102 of the anode plate 100. The cathode connector 113 is used as a current collector that extracts electricity from the cathode mixture layers 112 of the cathode plate 110.

### Structure of End Portion of Electrode Body 10

FIG. 3 is a perspective view showing a widthwise end of the rolled electrode body 10 at the anode side. The electrode body 10 obtained in a stacking step (S2 in FIG. 6) is rolled about the rolling axis while a center Ct is supported in a rolling step (S3 in FIG. 6). Then, in the roll pressing step (S4 in FIG. 6), the rolled electrode body 10 is pressed by two pressing surfaces 2a of a pressing unit 2 (refer to FIG. 4) so that the two ends of the electrode body 10 each have the shape of an athletic track as viewed in the widthwise direction W. The two pressing surfaces 2a face each other in a thickness-wise direction T orthogonal to a widthwise direction W. Subsequently, the flattened electrode body 10 is accommodated in the battery case 11 as shown in FIG. 1. The anode current collector 13 is welded to the anode connector 103, and the cathode current collector 15 is welded to the cathode connector 113. Examples of the method for welding a current collector to a connector include ultrasonic welding, resistance welding, and electric welding. The anode external terminal 14 is connected to the anode current collector 13 through the lid 12. The cathode external terminal 16 is connected to the cathode current collector 15 through the lid 12.

In this description, the widthwise direction W refers to a direction parallel to the rolling axis of the electrode body 10. The thickness-wise direction T refers to a direction orthogonal to the rolling axis of the electrode body 10 and a surface of a flat portion F. The lengthwise direction Z refers to a direction orthogonal to the widthwise direction W and the thickness-wise direction T.

### Flat Portion F and Bent Portion R

FIG. 4 is a schematic diagram showing the structure of an end of the electrode body 10 as viewed in the widthwise direction W. In the roll of the electrode body 10, the anode plate 100 and the cathode plate 110 are repeatedly stacked with the separators 120 disposed in between. The central portion of the flattened electrode body 10 is linear and defines the planar flat portion F (refer to FIG. 3) formed by the anode plate 100, the cathode plate 110, and the separators 120.

Further, at the upper end and the lower end of the flat portion F shown in FIG. 3, the electrode body 10 includes a bend portion R (refer to FIG. 3) formed by the stack of the anode plate 100, the cathode plate 110, and the separators 120 bent into the form of a semicircular column. The layers in the bent portion R are substantially concentric and semicircular as viewed in the widthwise direction W. The centers of the semicircles correspond to the center Ct. The center Ct may be considered as a straight line extending in the widthwise direction W.

### Anode Plate 100

The anode plate 100 includes the anode mixture layer 102 formed on the two opposite surfaces of the anode current collector foil 101. In the embodiment, the anode current collector foil 101 is formed by a copper (Cu) foil. The anode current collector foil 101 acts as the base for the anode mixture layers 102 and functions as a current collecting member that collects electricity from the anode mixture layers 102. In the anode plate 100, the anode mixture layers 102 are formed on the metal anode current collector foil 101. The anode mixture layer 102 includes an anode active material capable of storing and releasing lithium ions. In the present embodiment, the anode active material is a powder of a carbon material such as graphite or the like.

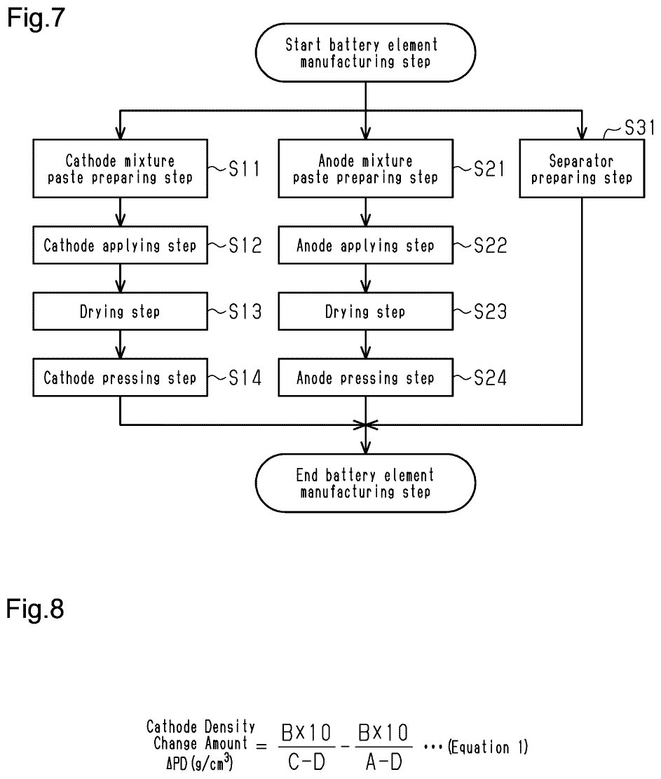

In the manufacture of the anode plate 100, for example, an anode active material paste is first prepared by kneading the anode active material, a solvent, and a binder (S21 in FIG. 7). The prepared anode mixture paste is applied to the anode current collector foil 101 (S22 in FIG. 7) and dried in a drying step (S23 in FIG. 7). Then, in an anode pressing step (S24 in FIG. 7), the anode plate 100 is pressed to have predetermined thickness and density.

### Cathode Plate 110

The cathode plate 110 includes the cathode mixture layer 112 formed on the two opposite surfaces of the cathode current collector foil 111. In the embodiment, the cathode current collector foil 111 is formed by an aluminum (Al) foil, an Al alloy foil, or the like. The cathode current collector foil 111 acts as the base for the cathode mixture layers 112 and functions as a current collecting member that collects electricity from the cathode mixture layers 112.

The cathode plate 110 includes the cathode mixture layers 112 formed on the surfaces of the cathode current collector foil 111. The cathode mixture layer 112 includes a cathode active material capable of storing and releasing lithium ions. The cathode active material may include, for example, lithium cobalt oxide (LiCoO₂), lithium manganese oxide (LiMn₂O₄), lithium nickel oxide (LiNiO₂), or the like. Alternatively, the cathode active material may be obtained by mixing LiCoO₂, LiMn₂O₄, and LiNiO₂ at a given ratio.

The cathode mixture layer 112 further includes a conductive material. The conductive material may include, for example, graphite or carbon black such as acetylene black (AB), ketjen black, or the like. The present embodiment uses carbon nanotubes, carbon nanofibers, or the like having a high conductivity so that the cathode weight per unit area B (mg/cm²) is decreased. This reduces the added amount of the conductive material and decreases the nonvolatile content ratio of the cathode mixture paste.

In the manufacture of the cathode plate 110, for example, a cathode mixture paste is first prepared by kneading the cathode active material, the conductive material, a solvent, and a binder (S11 in FIG. 7). The kneaded cathode mixture paste is applied to the cathode current collector foil 111 (S12 in FIG. 7), and then dried (S13 in FIG. 7). Finally, the cathode plate 110 is pressed in the cathode pressing step (S14 in FIG. 7) to have predetermined thickness and density.

### Separator 120

The separator 120 is a nonwoven fabric of polypropylene, which is a porous resin, or the like that has a superior insulation property and holds the non-aqueous electrolyte solution 17 between the anode plate 100 and the cathode plate 110. Further, the separator 120 may be any one of or a combination of a porous polymer film (e.g., porous polyethylene film, porous polyolefin film, porous polyvinyl chloride film, or the like) and a lithium-ion-conductive or ion-conductive polymer electrolyte film. Immersion of the electrode body 10 in the non-aqueous electrolyte solution 17 results in the non-aqueous electrolyte solution 17 permeating the separators 120 from the ends toward the middle part.

The resin separator 120 has a certain resiliency. Thus, even when a pressing force is temporarily applied, as in the roll pressing step (S4 in FIG. 6), the separator 120 restores the original thickness when the pressing force is no longer applied. However, when the pressing force exceeds a certain level (11 MPa in the present embodiment), the separator 120 undergoes plastic deformation and crushes the pores. The crushed pores will not return to the original sizes and decrease the porosity (%). This restricts movement of lithium ions Li⁺. Consequently, the internal resistance is irreversibly increased.

When manufacturing the separator 120, a porous sheet is extended in the lengthwise direction and the widthwise direction to adjust the pore sizes so that the porosity becomes adequate.

The separator 120 may be monolayered or multilayered. In the present embodiment, a core sheet is prepared from a porous sheet of polyethylene. When heated to a high temperature, the sheet melts and closes the pores to prevent movement of lithium ions Li⁺ so as to shut down the circuit. Further, two opposite surfaces of the core sheet are formed from a porous polypropylene sheet having high mechanical strength, heat resistance, and corrosion resistance in order to restrict micro-short circuits.

### Method for Manufacturing Lithium-Ion Rechargeable Battery 1

FIG. 6 is a flowchart illustrating an example of a method for manufacturing the lithium-ion rechargeable battery 1 of the present embodiment. In the method for manufacturing the lithium-ion rechargeable battery 1, which is a battery cell, a battery element manufacturing step (S1) first prepares power generating elements, namely, the anode plate 100, the cathode plate 110, and the separator 120. The battery element manufacturing step (S1) will be described later with reference to FIG. 7. After the anode plate 100, the cathode plate 110, and the separator 120 are prepared in the battery element manufacturing step (S1), a stacking step (S2) stacks and integrates the anode plate 100, the cathode plate 110, and the separator 120. The rolling step (S3) rolls the stack in the lengthwise direction Z, as shown in FIG. 2. The rolled stack substantially has the form of an athletic track as viewed in widthwise direction W, as shown in FIG. 3. The rolled stack obtained in the rolling step (S3) is substantially plate-shaped. The roll pressing step (S4) presses such a roll with two opposing pressing surfaces 2a of the pressing unit 2 in the thickness-wise direction T, as indicated by the arrows shown in FIG. 4. The roll pressing step (S4) presses the electrode body 10 to a specified thickness (mm) such that the electrode body 10 will be accommodated in the battery case 11 shown in FIG. 1 without a gap. In this case, the roll shaping load PL (kN) is varied in accordance with the composition prepared in a cathode mixture paste preparing step (S11 in FIG. 7), the cathode weight per unit area B (mg/cm²) in the cathode applying step (S12), the thickness A (μm) of the cathode plate 110 after the cathode applying step (S12), the thickness C (μm) of the cathode plate 110 after the cathode pressing step (S14), and the like.

After the roll pressing step (S4) adjusts the thickness of the electrode body 10, an assembling step (S5) is performed. The assembling step (S5) attaches the anode current collector 13 and the cathode current collector 15 to the electrode body 10, and then attaches the anode external terminal 14 and the cathode external terminal 16 to the electrode body 10 through the lid 12, as shown in FIG. 1. The electrode body 10 is accommodated in the battery case 11. The lid 12 is welded to the battery case 11 to seal the opening. Since a liquid inlet 18 of the lid 12 is open at this stage, the inside of the cell is dried by heating the cell in a cell drying step (S6). When the inside of the cell is dried by the cell drying step (S6), a liquid injecting and sealing step (S7) injects the non-aqueous electrolyte solution 17 into the cell and seals the liquid inlet 18. This completes the assembly of the lithium-ion rechargeable battery 1.

Then, initial charging of the lithium-ion rechargeable battery 1 in an activation step (S8) forms a solid electrolyte interphase (SEI) coating. Further, an aging step stores the lithium-ion rechargeable battery 1 under a high temperature for an extended period of time to eliminate micro-short circuits.

When such an activation step (S8) is completed, an inspection step (S9) inspects the battery capacity, internal resistance, self-discharge, and open-circuit voltage (OCV) of the lithium-ion rechargeable battery 1. The lithium-ion rechargeable battery 1 that passed the inspection will be shipped as a product.

### Battery Element Manufacturing Step (S1)

FIG. 7 is a flowchart illustrating the battery element manufacturing step (S1) of the lithium-ion rechargeable battery 1 of the present embodiment.

The battery element manufacturing step (S1) manufactures power generating elements, namely, the anode plate 100, the cathode plate 110, and the separator 120.

The cathode mixture paste preparing step (S11) prepares a cathode mixture paste by kneading a cathode active material, conductive material, solvent, and binder.

In the present embodiment, the roll shaping load PL (kN) is varied by adjusting the composition prepared in the cathode mixture paste preparing step (S11) to control the thickness A (μm) of the cathode plate 110 after the cathode applying step (S12), the weight per unit area B (mg/cm²), the thickness C (μm) of the cathode plate 110 after the cathode pressing step, and the like.

In an example, an increase in the mixing amount of the solvent increases the thickness A (μm) of the cathode plate 110 after the cathode applying step (S12). Further, in relation with the cathode weight per unit area B (mg/cm²), a certain amount of the cathode active material is necessary to obtain an adequate battery capacity of the cathode. Thus, when carbon nanotubes are used as the conductive material, for example, the mass of the carbon nanotubes may be smaller than that of a granular carbon material because of its shape and conductivity. This reduces the nonvolatile content ratio of the cathode mixture paste, thereby decreasing the weight per unit area B (mg/cm²) of the cathode mixture paste.

The composition of the cathode mixture paste is adjusted in the above manner to control the thickness A (μm) of the cathode plate 110 after the cathode applying step (S12).

After the cathode applying step (S12), a drying step (S13) dries the cathode mixture layer 112 to vaporize the volatile elements, such as the solvent and the like of the cathode mixture layer 112, and hardens the cathode mixture layer 112. The cathode pressing step (S14) presses and shapes the cathode plate 110, dried in the drying step (S13), to have a predetermined thickness.

The battery element manufacturing step (S1) manufactures the anode plate 100 at the same time as the cathode plate 110. Although not described in detail, the anode plate 100 is manufactured through an anode mixture paste preparing step (S21), an anode applying step (S22), the drying step (S23), and the anode pressing step (S24).

Although not described in detail, the separator 120 is also manufactured through a separator preparing step (S31) at the same time as the cathode plate 110.

As described above, the above-described battery element manufacturing step (S1 in FIG. 6) manufactures the anode plate 100, the cathode plate 110, and the separator 120, which are power generating elements of the lithium-ion rechargeable battery 1.

### Stacking Step (S2)

The anode plate 100, the separator 120, the cathode plate 110, and the separator 120, which are manufactured in the battery element manufacturing step (S1), are stacked in this order as shown in FIGS. 2 and 4.

### Rolling Step (S3)

The anode plate 100, the cathode plate 110, and the separators 120, which are stacked in the stacking step (S2), are rolled as shown in FIGS. 2 and 3.

### Roll Pressing Step (S4)

The roll pressing step (S4) presses the roll of the electrode body 10 with the pressing surfaces 2a of the pressing unit 2 in the thickness-wise direction T, as shown in FIG. 4.

The load in the roll pressing step (S4), at which the difference ΔT between the thickness T₁ (mm) of the electrode body 10 pressed at 1.2 MPa after the roll pressing step (S4) and the thickness T₂ (mm) of the electrode body 10 pressed at 0.03 MPa after the roll pressing step (S4) is less than or equal to 0.4 mm, corresponds to the roll shaping load PL (MPa).

The thickness A (μm) of the cathode plate 110 after the cathode applying step, the weight per unit area B (mg/cm²), and the thickness C (μm) of the cathode plate 110 after the cathode pressing step are adjusted so that the roll shaping load PL (MPa) becomes less than or equal to 11 MPa.

In the present embodiment, the thickness of the cathode plate 110 after the cathode applying step (S12) is represented by A (μm), the cathode weight per unit area is represented by B (mg/cm²), the thickness of the cathode plate 110 after the cathode pressing step is represented by C (μm), and the thickness of the cathode current collector foil is represented by D (μm). When the cathode density change amount ΔPD (g/cm³) is obtained from Equation 1 shown in FIG. 8, the thickness A (μm) of the cathode plate 110 after the cathode applying step (S12), the cathode weight per unit area B (mg/cm²), the thickness C (μm) of the cathode plate 110 after the cathode pressing step, and the thickness D (μm) of the cathode current collector foil are adjusted so that the cathode density change amount ΔPD is less than or equal to 1.0 g/cm³. This sets the roll shaping load PL (MPa) to be less than or equal to 11 MPa in the roll pressing step (S4).

Further, the thickness A (μm) of the cathode plate 110 after the cathode applying step (S12), the cathode weight per unit area B (mg/cm²), the thickness C (μm) of the cathode plate 110 after the cathode pressing step, and the thickness D (μm) of the cathode current collector foil may be adjusted so that the cathode density change amount ΔPD is greater than or equal to 0.63 g/cm³. In this case, the particles of the cathode active material adhere to the conductive material and reduce the contact resistance between the cathode active material and the conductive material.

### Operation of the Present Embodiment

As shown in FIG. 4, when the roll of the electrode body 10 is pressed by the two pressing surfaces 2a and 2a of the pressing unit 2 in the roll pressing step (S4 in FIG. 6), the reaction force property of the cathode plate 110 dominantly affects the moldability. The separator 120 formed from porous polyolefin, such as polyethylene (PE), polypropylene (PP), and the like, has a certain level of resiliency. However, application of a large pressure greater than a certain level results in irreversible plastic deformation of the separator 120. Once the separator 120 is plastically deformed, crushed pores will lower water permeability and the like. This may impede flow of lithium ions Li⁺ and adversely affect the battery performance qualities.

The present inventors have found through experiments that if the roll shaping load PL (MPa) is less than or equal to 11 MPa, the roll pressing step can be performed without crushing the pores of the separator 120 even at room temperature.

Further, the present inventors have found that the roll shaping load PL (MPa) becomes less than or equal to 11 MPa when the cathode density change amount ΔPD (g/cm³) is less than or equal to 1.0 g/cm³.

Accordingly, a condition in which the cathode density change amount ΔPD (g/cm³) becomes less than or equal to 1.0 g/cm³ needs to be proved. Thus, the following experiment was conducted to obtain the relationship between the thickness A (μm) of the cathode plate 110 after the cathode applying step, the weight per unit area B (mg/cm²), the thickness C (μm) of the cathode plate 110 after the cathode pressing step, the thickness D (μm) of the cathode current collector foil, and the cathode density change amount ΔPD (g/cm³).

### EXPERIMENTAL EXAMPLES

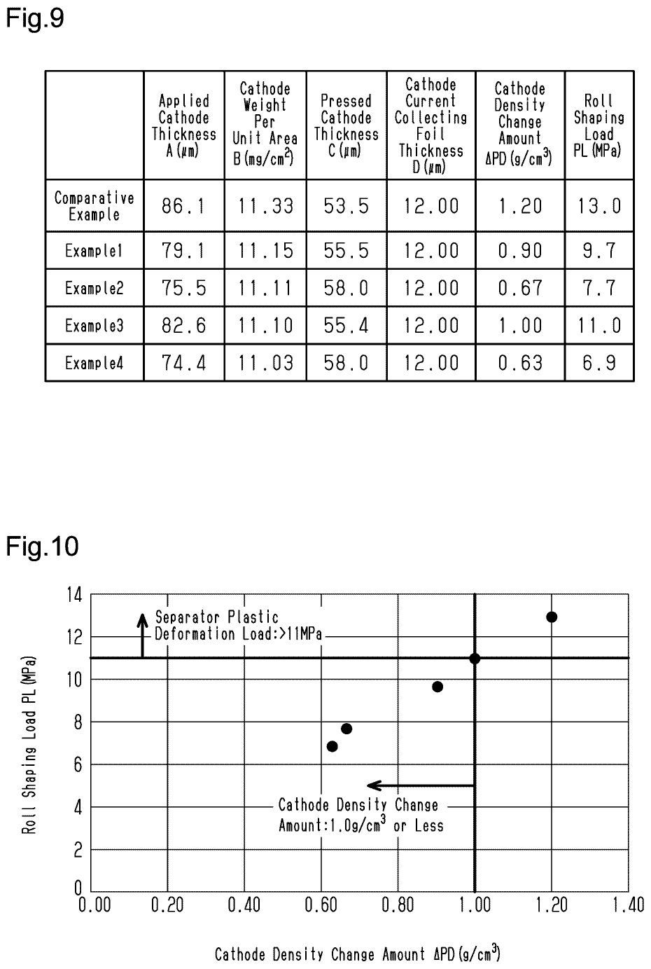

Experimental examples of the present embodiment are shown below. FIG. 9 is a table showing test results of examples of and a comparative example of the present embodiment. In the experiment, the following items were measured for Comparative Example and Examples 1 to 4.

First, the thickness D (μm) of the cathode current collector foil 111 was measured in advance. The common cathode current collector foil 111 had the thickness D of 12.00 μm.

Next, the cathode mixture paste having a predetermined composition was prepared in the cathode mixture paste preparing step (S11). Subsequently, the cathode mixture paste was applied to the cathode current collector foil 111 at a predetermined cathode weight per unit area B (mg/cm²) in the cathode applying step (S12). The thickness A (μm) of the cathode plate 110 was measured after the cathode mixture paste was applied. Then, the cathode mixture layer 112 was dried and pressed in the cathode pressing step (S14). The thickness C (μm) of the cathode plate 110 was measured after the cathode mixture layer 112 was pressed.

The thickness of the cathode plate 110 after the cathode applying step (S12) was represented by A (μm). The cathode weight per unit area was represented by B (mg/cm²). The thickness of the cathode plate 110 after the cathode pressing step (S14) was represented by C (μm). The thickness of the cathode current collector foil 111 was represented by D (μm). In this case, the cathode density change amount ΔPD (g/cm³) was obtained from Equation 1 shown in FIG. 8. In Equation 1, numerators of the right-hand side were multiplied by ten to match the unit.

Comparison Example and Examples 1 to 4 were compared.

### Conditions of Experiments

### Comparative Example

The thickness A of the cathode plate 110 after the cathode applying step was 86.1 μm, the cathode weight per unit area B was 11.33 mg/cm², the thickness C of the cathode plate 110 after the cathode pressing step was 53.5 μm, and the cathode current collector foil thickness D was 12.00 μm. The cathode density change amount ΔPD obtained from Equation 1 was 1.20 g/cm³. In this case, the roll shaping load PL was 13.0 MPa.

### Example 1

The thickness A of the cathode plate 110 after the cathode applying step was 79.1 μm, the cathode weight per unit area B was 11.15 mg/cm², the thickness C of the cathode plate 110 after the cathode pressing step was 55.5 μm, and the cathode current collector foil thickness D was 12.00 μm. The cathode density change amount ΔPD obtained from Equation 1 was 0.90 g/cm³. In this case, the roll shaping load PL was 9.7 MPa.

### Example 2

The thickness A of the cathode plate 110 after the cathode applying step was 75.5 μm, the cathode weight per unit area B was 11.11 mg/cm², the thickness C of the cathode plate 110 after the cathode pressing step was 58.0 μm, and the cathode current collector foil thickness D was 12.00 μm. The cathode density change amount ΔPD obtained from Equation 1 was 0.67 g/cm³. In this case, the roll shaping load PL was 7.7 MPa.

### Example 3

The thickness A of the cathode plate 110 after the cathode applying step was 82.6 μm, the cathode weight per unit area B was 11.10 mg/cm², the thickness C of the cathode plate 110 after the cathode pressing step was 55.4 μm, and the cathode current collector foil thickness D was 12.00 μm. The cathode density change amount ΔPD obtained from Equation 1 was 1.00 g/cm³. In this case, the roll shaping load PL was 11.0 MPa.

### Example 4

The thickness A of the cathode plate 110 after the cathode applying step was 74.4 μm, the cathode weight per unit area B was 11.03 mg/cm₂, the thickness C of the cathode plate 110 after the cathode pressing step was 58.0 μm, and the cathode current collector foil thickness D was 12.00 μm. The cathode density change amount ΔPD obtained from Equation 1 was 0.63 g/cm³. In this case, the roll shaping load PL was 6.9 MPa.

### Summary of Experiment

As shown in FIG. 4, when the roll of the electrode body 10 is pressed by the two pressing surfaces 2a and 2a of the pressing unit 2 in the roll pressing step (S4 in FIG. 6), the reaction force property of the cathode plate 110 dominantly affects the moldability. The separator 120 formed from porous polyolefin, such as polyethylene (PE), polypropylene (PP), and the like, has a certain level of resiliency. However, application of a certain level of pressure plastically deforms the separator 120. Once the separator 120 is plastically deformed, crushed pores will lower water permeability and the like. This may impede flow of lithium ions Li⁺ and adversely affect the battery performance qualities. The present inventors have confirmed through experiments that when the roll shaping load PL (MPa) is less than or equal to 11 MPa, plastic deformation of the separator 120 is avoided such that lithium ions Li⁺ will be smoothly exchanged through the pores.

Therefore, the inventors set a reference threshold value PLth of the roll shaping load PL (MPa) to 11 MPa, and adjusted the roll shaping load PL (MPa) to be 11 MPa or less to analyze the condition under which the roll pressing step (S4 in FIG. 6) can be performed without crushing the pores of the separator 120 even at room temperature.

### Experiment Results

In the Comparison Example, the roll shaping load PL was 13.0 MPa, which was greater than the threshold value PLth (MPa). This indicates that plastic deformation of the separator 120 was not avoided. In contrast, in Examples 1 to 4, the roll shaping load PL was in a range of 6.9 MPa to 11.0 MPa, which was less than the threshold value PLth (MPa). This indicates that plastic deformation of the separator 120 was avoided.

The cathode density change amount ΔPD was 1.20 g/cm³ in the Comparative Example, and in a range of 0.63 g/cm³ to 1.00 g/cm³ in Examples 1 to 4.

These results indicate that when the cathode density change amount ΔPD is 1.00 g/cm³ or less, the roll shaping load PL (MPa) becomes less than or equal to the reference threshold value PLth of 11 MPa.

Thus, values of the thickness A (μm), the cathode weight per unit area B (mg/cm²), and the thickness C (μm) in Equation 1 are determined such that the cathode density change amount ΔPD becomes less than or equal to 1.00 g/cm³. This readily sets the roll shaping load PL (MPa) to be less than or equal to 11 MPa.

Specific values of the thickness A (μm) after the cathode applying step, the cathode weight per unit area B (mg/cm²), and the thickness C (μm) after the cathode pressing step are as follows.

When the thickness A after the cathode applying step is in a range of 74.4 μm to 82.6 μm, the roll shaping load PL (MPa) becomes less than or equal to the reference threshold value PLth of 11 MPa.

When the cathode weight per unit area B is in a range of 11.03 mg/cm² to 11.15 mg/cm², the roll shaping load PL (MPa) becomes less than or equal to the reference threshold value PLth of 11 MPa.

When the thickness C after the cathode pressing step is in a range of 55.4 μm to 58.0 μm, the roll shaping load PL (MPa) becomes less than or equal to the reference threshold value PLth of 11 MPa.

### Operation of the Present Embodiment

FIG. 10 is a graph showing the relationship between the cathode density change amount ΔPD (g/cm³) and the roll shaping load PL (MPa) of the present embodiment. The results of the experiment plotted on the graph show the relationship of the cathode density change amount ΔPD (g/cm³) represented by the horizontal axis and the roll shaping load PL (MPa) represented by the vertical axis. The graph shows that the cathode density change amount ΔPD (g/cm³) and the roll shaping load PL (MPa) have a strong positive correlation. This confirms that when the cathode density change amount ΔPD is less than or equal to 1.0 g/cm³, the roll shaping load PL (MPa) becomes less than or equal to 11 MPa, at which the separator 120 undergoes plastic deformation.

### Advantages of the Present Embodiment

(1) The method for manufacturing the lithium-ion rechargeable battery 1 in accordance with the present embodiment readily avoids excessive plastic deformation of the separator 120 when the electrode body 10 is pressed.
(2) The thickness A (μm) of the cathode plate 110 after the cathode applying step, the cathode weight per unit area B (mg/cm²), and the thickness C (μm) of the cathode plate 110 after the cathode pressing step are adjusted so that the roll shaping load PL (MPa) becomes less than or equal to 11 MPa after the roll pressing step (S4). This readily minimizes movement resistance of lithium ions Li⁺ resulting from plastic deformation of the separator 120 in the roll pressing step.
(3) The thickness of the cathode plate 110 after the cathode applying step (S12) is represented by A (μm), the cathode weight per unit area is represented by B (mg/cm²), the thickness of the cathode plate 110 after the cathode pressing step (S14) is represented by C (μm), and the thickness of the cathode current collector foil 111 is represented by D (μm). In this case, the cathode density change amount ΔPD (g/cm³) is obtained from Equation 1 shown in FIG. 8. The values A (μm), B (mg/cm²), C (μm), and D (μm) are adjusted so that the cathode density change amount ΔPD is less than or equal to 1.0 g/cm³. This readily sets the roll shaping load PL (MPa) to less than or equal to 11 MPa.
(4) Further, the values are adjusted so that the cathode density change amount ΔPD is greater than or equal to 0.63 g/cm³. In this case, the particles of the cathode active material adhere to the conductive material and reduce the contact resistance between the cathode active material and the conductive material.
(5) In the present embodiment, the electrode body 10 is not heated and the roll shaping load PL (MPa) is less than or equal to 11 MPa at room temperature. This eliminates the need for a heating facility.
(6) Furthermore, elimination of a heat treatment shortens the production time and improves the production efficiency.
(7) In the present embodiment, the cathode mixture layer 112 includes a conductor that includes carbon nanotubes. The fibrous carbon nanotubes having a high conductivity reduce the amount of conductive material added to form a conductive network. This decreases the density of the cathode mixture layer 112. As a result, the cathode mixture paste is readily prepared.
(8) The manufacturing method of the present embodiment may be performed with the lithium-ion rechargeable battery 1.

### MODIFIED EXAMPLES

The above embodiment is an example of the present disclosure and may be modified as follows.

In the present embodiment, the lithium-ion rechargeable battery 1, which is a plate-shaped battery cell to be mounted on a vehicle, is described as an example of a non-aqueous electrolyte solution rechargeable battery. However, the non-aqueous electrolyte solution rechargeable battery is not limited to such a structure and may be, for example, stationary.

The drawings are provided to illustrate the present embodiment, and depiction of elements may be exaggerated or simplified for clarity. Thus, the present disclosure is not limited to the drawings.

The flowcharts illustrated in FIGS. 6 and 7 are examples of the present disclosure. Steps may be added, removed, reordered, or switched.

The composition, material properties, and the like of the cathode mixture paste are merely examples of the present disclosure and may be optimized by one skilled in the art.

The present embodiment is an embodiment of the present disclosure and is not restrictive. One skilled in the art may add, remove, or change the structure within the scope of the claims.

The present disclosure includes the following embodiments. Reference numerals are assigned to the components in the embodiments in order to facilitate understanding without limiting the scope of the present disclosure.

### Embodiment 1

A method for manufacturing a flat rolled electrode body (10) for a non-aqueous electrolyte solution rechargeable battery (1), the method includes:
forming a cathode plate (110) by applying a cathode mixture layer (112) to a cathode current collector foil (111);
pressing the formed cathode plate;
forming a stack by stacking the pressed cathode plate and an anode plate (100), including an anode current collector foil (101) and an anode mixture layer (102), with a separator (120) formed from a porous resin arranged in between;
forming a rolled electrode body by rolling the stack; and
pressing the rolled electrode body to flatten the rolled electrode body;
in which when a roll shaping load PL (MPa) corresponds a load in the pressing the rolled electrode body at which a difference ΔT between a thickness T₁ (mm) of the electrode body pressed at 1.2 MPa after the pressing the rolled electrode body and a thickness T₂ (mm) of the electrode body pressed at 0.03 MPa after the pressing the rolled electrode body is less than or equal to 0.4 mm,
   a thickness A (μm) of the cathode plate, a cathode weight per unit area B (mg/cm²) of the applied cathode mixture layer, and a thickness C (μm) of the pressed cathode plate are adjusted so that the roll shaping load PL (MPa) is less than or equal to 11 MPa.

### Embodiment 2

A method for manufacturing a flat rolled electrode body (10) for a non-aqueous electrolyte solution rechargeable battery (1), the method includes:
forming a cathode plate (110) by applying a cathode mixture layer (112) to a cathode current collector foil (111);
pressing the formed cathode plate;
forming a stack by stacking the pressed cathode plate and an anode plate (100), including an anode current collector foil (101) and an anode mixture layer (102), with a separator (120) formed from a porous resin arranged in between;
forming a rolled electrode body by rolling the stack; and
pressing the rolled electrode body to flatten the rolled electrode body;
in which when a cathode density change amount ΔPD (g/cm³) is obtained from Equation 1 shown in FIG. 8, where A (μm) represents a thickness of the cathode plate, B (mg/cm²) represents a cathode weight per unit area of the applied cathode mixture layer, C (μm) represents a thickness of the pressed cathode plate, and D (μm) represents a thickness of the cathode current collector foil,
   the thickness A (μm) of the cathode plate, the cathode weight per unit area B (mg/cm²), the thickness C (μm) of the pressed cathode plate, and the thickness D (μm) of the cathode current collector foil are adjusted so that the cathode density change amount ΔPD is less than or equal to 1.0 g/cm³.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing an electrode body for a non-aqueous electrolyte solution rechargeable battery, the non-aqueous electrolyte solution rechargeable battery including the electrode body, a non-aqueous electrolyte solution, and a box-shaped battery case accommodating the electrode body and the non-aqueous electrolyte solution, the method comprising:
a cathode applying step of applying a cathode mixture layer on a cathode current collector foil of the electrode body to form a cathode plate;
a cathode pressing step of pressing the formed cathode plate;
a stacking step of stacking the pressed cathode plate and an anode plate, including an anode current collector foil and an anode mixture layer, with a separator formed from a porous resin arranged in between;
a rolling step of rolling the stacked electrode body; and
a roll pressing step of pressing the rolled electrode body to flatten the rolled electrode body,
wherein, when a roll shaping load PL (MPa) corresponds to a load in the roll pressing step at which a difference ΔT between a thickness T₁ mm of the electrode body pressed at 1.2 MPa after the roll pressing step and a thickness T₂ of the electrode body pressed at 0.03 MPa after the roll pressing step is less than or equal to 0.4 mm,
a thickness A (μm) of the cathode plate after the cathode applying step, a cathode weight per unit area B (mg/cm²) of the cathode mixture layer applied in the cathode applying step, and a thickness C (μm) of the cathode plate after the cathode pressing step are adjusted so that the roll shaping load PL (MPa) is less than or equal to 11 MPa.

2. The method according to claim 1, wherein, in the roll pressing step, the rolled electrode body is pressed at room temperature without heating the electrode body.

3. The method according to claim 1, wherein the cathode mixture layer includes a conductor, and the conductor includes carbon nanotubes.

4. The method according to claim 1, wherein the non-aqueous electrolyte solution rechargeable battery is a lithium-ion rechargeable battery.

5. A method for manufacturing a non-aqueous electrolyte solution rechargeable battery, the method comprising:
the method for manufacturing an electrode body for a non-aqueous electrolyte solution rechargeable battery according to claim 1.

6. A method for manufacturing an electrode body for a non-aqueous electrolyte solution rechargeable battery, the non-aqueous electrolyte solution rechargeable battery including the electrode body, a non-aqueous electrolyte solution, and a box-shaped battery case accommodating the electrode body and the non-aqueous electrolyte solution, the method comprising:
a cathode applying step of applying a cathode mixture layer on a cathode current collector foil of the electrode body to form a cathode plate;
a cathode pressing step of pressing the formed cathode plate;
a stacking step of stacking the pressed cathode plate and an anode plate, including an anode current collector foil and an anode mixture layer, with a separator formed from a porous resin arranged in between;
a rolling step of rolling the stacked electrode body; and
a roll pressing step of pressing the rolled electrode body to flatten the rolled electrode body,
wherein when a cathode density change amount ΔPD (g/cm³) is obtained from Equation 1, where A (μm) represents a thickness of the cathode plate after the cathode applying step, B (mg/cm²) represents a cathode weight per unit area of the cathode mixture layer applied in the cathode applying step, C (μm) represents a thickness of the cathode plate after the cathode pressing step, and D (μm) represents a thickness of the cathode current collector foil,
$$\begin{matrix}Cathode Density Change Amount \\ Δ PD ( g / {cm}^{3} )\end{matrix} = \frac{B \times 10}{C - D} - \frac{B \times 10}{A - D} \qquad ( Equation 1 )$$
the thickness A (μm) of the cathode plate after the cathode applying step, the cathode weight per unit area B (mg/cm²), the thickness C (μm) of the cathode plate after the cathode pressing step, and the thickness D (μm) of the cathode current collector foil are adjusted so that the cathode density change amount ΔPD is less than or equal to 1.0 g/cm³.

7. The method according to claim 6, wherein the thickness A (μm) of the cathode plate after the cathode applying step, the cathode weight per unit area B (mg/cm²), the thickness C (μm) of the cathode plate after the cathode pressing step, and the thickness D (μm) of the cathode current collector foil are adjusted so that the cathode density change amount ΔPD is greater than or equal to 0.63 g/cm³.

8. The method according to claim 6, wherein, in the roll pressing step, the rolled electrode body is pressed at room temperature without heating the electrode body.

9. The method according to claim 6, wherein the cathode mixture layer includes a conductor, and the conductor includes carbon nanotubes.

10. The method according to claim 6, wherein the non-aqueous electrolyte solution rechargeable battery is a lithium-ion rechargeable battery.

11. A method for manufacturing a non-aqueous electrolyte solution rechargeable battery, the method comprising:
the method for manufacturing an electrode body for a non-aqueous electrolyte solution rechargeable battery according to claim 6.
